(19) United States
(12) Patent Application Publication
(10) Pub. No.: US 2026/0292207 A1
(43) Pub. Date: Sep. 24, 2026

(54) VIDEO CODING METHOD AND APPARATUS

(71) Applicant: Tencent Technology (Shenzhen) Company Limited, Shenzhen (CN)

(72) Inventor: Xiaozhong XU, Shenzhen (CN)

(73) Assignee: Tencent Technology (Shenzhen) Company Limited, Shenzhen (CN)

(21) Appl. No.: 19/691,451

(22) Filed: May 28, 2026

Related U.S. Application Data
(63) Continuation of application No. PCT/CN2025/104438, filed on Jun. 27, 2025.

(30) Foreign Application Priority Data
Jul. 30, 2024 (CN) 202411031303.X

(51) Int. Cl. H04N 19/159; H04N 19/105; H04N 19/176; H04N 19/593

(52) U.S. Cl. CPC H04N 19/159; H04N 19/105; H04N 19/176; H04N 19/593

(57) ABSTRACT

Aspects of the disclosure provide a video decoding method and a video encoding method. In the video decoding method, residual correction information corresponding to a current block that is intra-coded is obtained from a bitstream. A correction value is decoded from the residual correction information. At least one residual value of the current block is corrected based on the correction value to obtain a corrected residual value. The current block is reconstructed based on the corrected residual value. Apparatus and non-transitory computer-readable storage medium counterpart embodiments are also contemplated.

### RELATED APPLICATIONS

The present application is a continuation of International Application No. PCT/CN2025/104438, filed on Jun. 27, 2025, which claims priority to Chinese Patent Application No. 202411031303.X, filed on Jul. 30, 2024. The entire disclosures of the prior applications are hereby incorporated by reference.

### FIELD OF THE TECHNOLOGY

This disclosure relates to the field of video processing technologies, including a video coding method and apparatus, a video decoding method and apparatus, an electronic device, and a computer-readable medium.

### BACKGROUND OF THE DISCLOSURE

To adapt to large-scale data transmission of video data, original video data usually needs to be coded on a data transmitter side to form a compressed data bitstream. After the data bitstream is transmitted to a data receiver side, the data bitstream is decoded and restored to obtain predicted and reconstructed video data.

### SUMMARY

Aspects of this disclosure provide a video coding method and apparatus, a video decoding method and apparatus, an electronic device, a computer-readable storage medium, and a computer program product, to improve accuracy and efficiency of current block reconstruction, and achieve high reliability of video coding and decoding.

An aspect of this disclosure provides a video decoding method. In the video decoding method. Residual correction information corresponding to a current block that is intra-coded is obtained from a bitstream. A correction value is decoded from the residual correction information. At least one residual value of the current block is corrected based on the correction value to obtain a corrected residual value. The current block is reconstructed based on the corrected residual value. Apparatus and non-transitory computer-readable storage medium counterpart embodiments are also contemplated.

An aspect of this disclosure provides a video encoding method. In the video encoding method, a predictive coding mode corresponding to a current block in a video image is determined as intra prediction. A correction value corresponding to the current block is generated. The correction value is encoded into residual correction information. The residual correction information is encoded into a coded video bitstream corresponding to the video image.

An aspect of this disclosure provides a non-transitory computer-readable storage medium. The non-transitory computer-readable storage medium stores instructions which, when executed by a processor, cause the processor to perform a method of encoding a video bitstream. In the method, a predictive coding mode corresponding to a current block in a video image is determined as intra prediction. A correction value corresponding to the current block is generated. The correction value is encoded into residual correction information. The residual correction information is encoded into a coded video bitstream corresponding to the video image. The coded video bitstream is transmitted.

An aspect of this disclosure provides a video decoding method. The method includes: obtaining, from a bitstream, residual correction information corresponding to a current block, the current block being an intra-coded image block in the bitstream; decoding the residual correction information into a correction value; correcting at least one residual value of the current block by using the correction value to obtain a corrected residual value; and reconstructing the current block based on the corrected residual value.

An aspect of this disclosure further provides a video coding method. The method includes: generating, in response to determining that a predictive coding mode corresponding to a to-be-coded current block in a video image is intra prediction, a correction value corresponding to the current block; coding the correction value into residual correction information; and coding the residual correction information into a coded video bitstream corresponding to the video image.

An aspect of this disclosure provides a video decoding apparatus. The apparatus includes: an obtaining apparatus, configured to obtain, from a bitstream, residual correction information corresponding to a current block, the current block being an intra-coded image block in the bitstream; a decoding module, configured to decode the residual correction information into a correction value; a correction module, configured to correct at least one residual value of the current block by using the correction value to obtain a corrected residual value; and a reconstruction module, configured to reconstruct the current block based on the corrected residual value.

An aspect of this disclosure further provides a video coding apparatus. The apparatus includes: a generation module, configured to generate, in response to determining that a predictive coding mode corresponding to a to-be-coded current block in a video image is intra prediction, a correction value corresponding to the current block; a coding module, configured to code the correction value into residual correction information; and a bitstream generation module, configured to code the residual correction information into a coded video bitstream corresponding to the video image.

An aspect of this disclosure further provides an electronic device, including: processing circuitry (e.g., one or more processors); and a memory, configured to store one or more programs, the one or more programs, when executed by the one or more processors, causing the electronic device to implement the video coding methods and the video decoding methods in the aspects.

An aspect of this disclosure further provides a computer-readable storage medium (e.g., a non-transitory computer-readable storage medium), having a video bitstream stored therein, the video bitstream being decoded by using the video decoding methods in the aspects or generated by using the coding methods in the aspects.

An aspect of this disclosure further provides a computer program product, including a computer program, the computer program, when executed by a processor, implementing the video coding methods and the video decoding methods in the aspects.

In the aspects of this disclosure, some residual values of a current block are corrected, and the current block is reconstructed by using the corrected residual values, to avoid a phenomenon of uneven quantization loss caused by different correlations between the residual values and a reference region, so that accuracy and efficiency of reconstructing the current block are higher. For example, the accuracy and efficiency of reconstructing the current block are improved, and reliability of video coding and decoding is high.

### BRIEF DESCRIPTION OF THE DRAWINGS

FIG. 1 shows a schematic diagram of a system architecture to which technical solutions of aspects of this disclosure may be applied.

FIG. 2 shows an example of a manner of placing a video coding apparatus and a video decoding apparatus in a streaming environment according to some aspects of this disclosure.

FIG. 3 shows a basic flowchart of a coding process performed by a video coder according to some aspects of this disclosure.

FIG. 4 shows a schematic diagram of an example of a residual value obtained through intra prediction according to some aspects of this disclosure.

FIG. 5 shows a flowchart of a video decoding method according to some aspects of this disclosure.

FIG. 6 shows a flowchart of a video decoding method according to some aspects of this disclosure.

FIG. 7A shows a schematic diagram of an example of a residual value before correction according to some aspects of this disclosure.

FIG. 7B shows a schematic diagram of an example of a corrected residual value according to some aspects of this disclosure.

FIG. 8 shows a flowchart of a video decoding method according to some aspects of this disclosure.

FIG. 9 shows a schematic diagram of an example of an image block coding sequence according to some aspects of this disclosure.

FIG. 10A shows a schematic diagram of an example of correction according to some aspects of this disclosure.

FIG. 10B shows a schematic diagram of an example of correction according to some aspects of this disclosure.

FIG. 10C shows a schematic diagram of an example of correction according to some aspects of this disclosure.

FIG. 11 shows a flowchart of a video decoding method according to some aspects of this disclosure.

FIG. 12 shows a flowchart of a video coding method according to some aspects of this disclosure.

FIG. 13 shows a flowchart of a video coding method according to some aspects of this disclosure.

FIG. 14 shows a block diagram of a video decoding apparatus according to some aspects of this disclosure.

FIG. 15 shows a block diagram of a video coding apparatus according to some aspects of this disclosure.

FIG. 16 shows a schematic structural diagram of a computer system suitable for implementing an electronic device according to some aspects of this disclosure.

### DETAILED DESCRIPTION

The following describes technical solutions in aspects of this disclosure with reference to the accompanying drawings. The described aspects are merely some rather than all aspects of this disclosure. Other aspects obtained by persons of ordinary skill in the art based on aspects of this disclosure fall within this disclosure.

In this disclosure, the term “at least one” means one or more, and “a plurality of” means two or more. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The block diagrams shown in the accompanying drawings are merely functional entities rather than other corresponding to physically independent entities. For example, these functional entities may be implemented in a software form, or in one or more hardware modules or integrated circuits, or in different networks, processor apparatuses, and/or micro-controller apparatuses.

The flowcharts shown in the accompanying drawings are merely examples of descriptions rather than including all content and operations, and do not have to be executed in the described order. For example, some operations may further be broken down, and some other operations may be merged or partially merged. Therefore, an actual execution order may change according to an actual situation.

“A plurality of” mentioned in this disclosure means two or more. “And/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

The terms “first”, “second”, “third”, and “fourth” in the specification, claims, and accompanying drawings of this disclosure are configured for distinguishing between different objects, and are not configured for describing a specific sequence. The terms “including”, “having”, or any other variant thereof are intended to cover a non-exclusive inclusion. For example, a process, method, system, product, or device including a series of operations or units is not limited to the listed operations or units, but instead, in some aspects, includes operations or units that are not listed, or in some aspects, includes other operations or units inherent to the process, method, product, or device.

“Aspects of this disclosure” below refers to various aspects of this disclosure, including all implementations explicitly described in the specification and claims, and all implementations that may be derived from these descriptions unambiguously.

In the aspects of this disclosure, the term “module” or “unit” refers to a computer program with a preset function or a part of the computer program and works, together with other related parts, to implement a preset target, and may be completely or partially implemented by using software, hardware (e.g., a processing circuit or a memory) or a combination thereof. Similarly, one processor (or a plurality of processors or memories) may be configured to implement one or more modules or units. In addition, each module or unit may be a part of an overall module or unit including a function of the module or unit.

For ease of understanding the technical solutions provided in the aspects of this disclosure, a video coding/decoding process is first described. Descriptions of terms in this disclosure are provided as examples only and are not intended to limit the scope of the disclosure.

Video coding can refer to processing a picture sequence that forms a video or a video sequence. In the field of video coding, terms “picture”, “frame”, or “image” may be used as synonyms. Video coding used in the aspects of this disclosure indicates video coding or video decoding. Video coding is performed on a source side, and can include processing (e.g., compressing) an original video image to reduce a data volume required for representing the video image, for more efficient storage and/or transmission. Video decoding is performed on a destination side, and can include performing inverse processing relative to a coder, to reconstruct a video image. In this aspect, “coding” of a video frame is required to be understood as “coding” or “decoding” of a video image sequence. A combination of a coding part and a decoding part is also referred to as coding/decoding (coding and decoding).

Each image in the video image sequence can be divided into a non-overlapping block set, and coding can be performed on a block level. In other words, a coder side can process, for example, codes a video, at a block (also referred to as an image block or a video block) level. For example, a prediction block is generated by means of space (intra-image) prediction and time (inter-image) prediction, and the prediction block is subtracted from a current block (a currently processed or to-be-processed block) to obtain a residual block. The residual block is transformed in a transform domain and the residual block is quantized, so as to reduce a to-be-transmitted (compressed) data volume. A decoder side applies an inverse process of coder processing to a coded or compressed block, to reconstruct the current block. In addition, the coder copies a processing cycle of the decoder, so that the coder and the decoder generate the same prediction (e.g., intra prediction and inter prediction) and/or reconstruction for processing, for example, coding, a subsequent block.

The term “block” is a part of an image or a frame. In the aspects of this disclosure, the current block is a block that is being processed currently. For example, during coding, the current block refers to a block that is being coded currently. During decoding, the current block refers to a block that is being currently decoded.

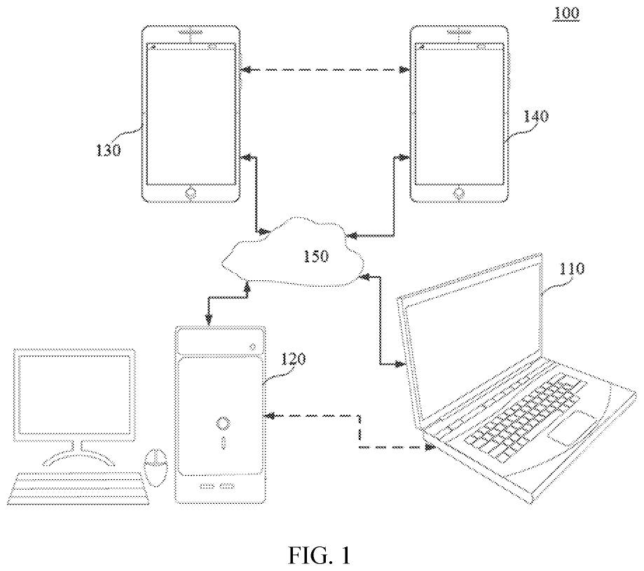

FIG. 1 shows a schematic diagram of a system architecture to which technical solutions of aspects of this disclosure may be applied. As shown in FIG. 1, a system architecture 100 includes a plurality of terminal apparatuses. The plurality of terminal apparatuses may communicate with each other through, for example, a network 150. For example, the system architecture 100 may include a first terminal apparatus 110 and a second terminal apparatus 120 that are interconnected through the network 150. In the aspect of FIG. 1, the first terminal apparatus 110 and the second terminal apparatus 120 perform unidirectional data transmission.

For example, the first terminal apparatus 110 may code video data (e.g., a video picture stream acquired by the terminal apparatus 110) for transmission to the second terminal apparatus 120 through the network 150. The coded video data is transmitted in a form of one or more coded video bitstreams. The second terminal apparatus 120 may receive the coded video data from the network 150, decode the coded video data to restore the video data, and display a video picture according to the restored video data.

In the aspects of this disclosure, the system architecture 100 may include a third terminal apparatus 130 and a fourth terminal apparatus 140 that perform bidirectional transmission of the coded video data. The bidirectional transmission may occur, for example, during a video conference. For bidirectional data transmission, each of the third terminal apparatus 130 and the fourth terminal apparatus 140 may code video data (e.g., a video picture stream acquired by the terminal apparatus) for transmission to the other terminal apparatus of the third terminal apparatus 130 and the fourth terminal apparatus 140 through the network 150. Each of the third terminal apparatus 130 and the fourth terminal apparatus 140 may further receive the coded video data transmitted by the other terminal apparatus of the third terminal apparatus 130 and the fourth terminal apparatus 140, decode the coded video data to restore the video data, and display a video picture on an accessible display apparatus according to the restored video data.

In the aspect of FIG. 1, the first terminal apparatus 110, the second terminal apparatus 120, the third terminal apparatus 130, or the fourth terminal apparatus 140 may be a server, a personal computer, or a smartphone, but the principles disclosed in this disclosure may not be limited thereto. The aspects disclosed in this disclosure are applicable to a laptop computer, a tablet computer, a media player, and/or a dedicated video conference device. The network 150 represents any number of networks for transmitting coded video data between the first terminal apparatus 110, the second terminal apparatus 120, the third terminal apparatus 130, and the fourth terminal apparatus 140, and includes, for example, a wired and/or wireless communication network. The network 150 may exchange data in a circuit-switched and/or packet-switched channel. The network may include a telecommunication network, a local area network (LAN), a wide area network, and/or the Internet. For the purpose of this disclosure, unless explained below, an architecture and a topology of the network 150 may be inconsequential to operations disclosed in this disclosure.

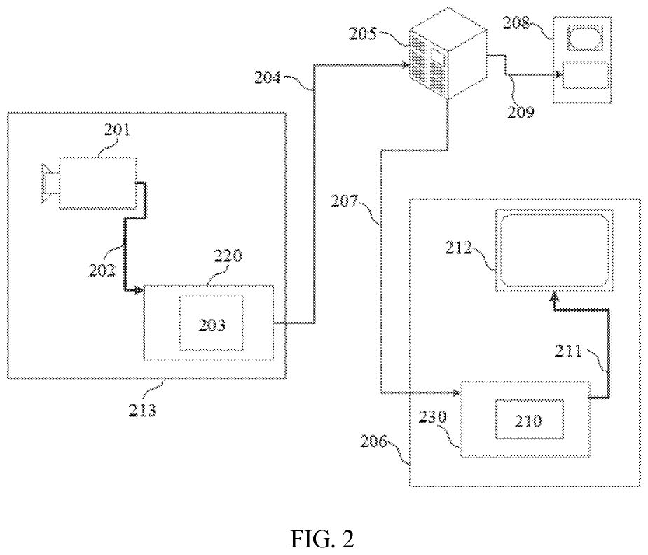

FIG. 2 shows a manner of placing a video coding apparatus and a video decoding apparatus in a streaming environment. The subject disclosed in this disclosure may be equally applicable to other applications supporting video, including, for example, video conferencing, a digital television (TV), and storing a compressed video in a digital medium including a CD, a DVD, and a storage stick.

A streaming system may include an acquisition subsystem 213. The acquisition subsystem 213 may include a video source 201 such as a digital camera. The video source creates an uncompressed video picture stream 202. In an aspect, the video picture stream 202 includes a sample shot by the digital camera. Compared with coded video data 204 (or a coded video bitstream 204), the video picture stream 202 is drawn as a bold line to emphasize a video picture stream with a high data volume. The video picture stream 202 may be processed by an electronic apparatus 220. The electronic apparatus 220 includes a video coding apparatus 203 coupled to the video source 201. The video coding apparatus 203 may include hardware, software, or a combination of software and hardware to realize or implement aspects of the disclosed subject described in further detail below. Compared with the video picture stream 202, the coded video data 204 (or the coded video bitstream 204) is drawn as a thin line to emphasize that the coded video data 204 (or the coded video bitstream 204) of a relatively low data volume may be stored on a streaming server 205 for future use. One or more streaming client subsystems, for example, a client subsystem 206 and a client subsystem 208 in FIG. 2, may access the streaming server 205 to retrieve a copy 207 of the coded video data 204 and a copy 209 of the coded video data 204. The client subsystem 206 may include, for example, a video decoding apparatus 210 in an electronic apparatus 230. The video decoding apparatus 210 decodes the incoming copy 207 of coded video data 204, and generates an output video picture stream 211 that may be presented on a display 212 (e.g., a display screen) or another presentation apparatus. In some streaming systems, the coded video data 204, the copy 207 of the coded video data 204, and the copy 209 of the coded video data 204 (e.g., video bitstreams) may be coded according to some video coding/compression standards.

The electronic apparatus 220 and the electronic apparatus 230 may include other components not shown in the figure. For example, the electronic apparatus 220 may include a video decoding apparatus, and the electronic apparatus 230 may further include a video coding apparatus.

In an aspect of this disclosure, by using high efficiency video coding (HEVC, H.265), versatile video coding (VVC, H.266), or audio video coding standard (AVS) as an example, after a video frame image is inputted, the video frame image is divided into several non-overlapping processing units according to a block size. Each processing unit performs a similar compression operation. This processing unit is referred to as a coding tree unit (CTU) or a largest coding unit (LCU). The CTU may be further subdivided more finely, to obtain one or more basic coding units (CU). The CU is a most basic element in a coding section.

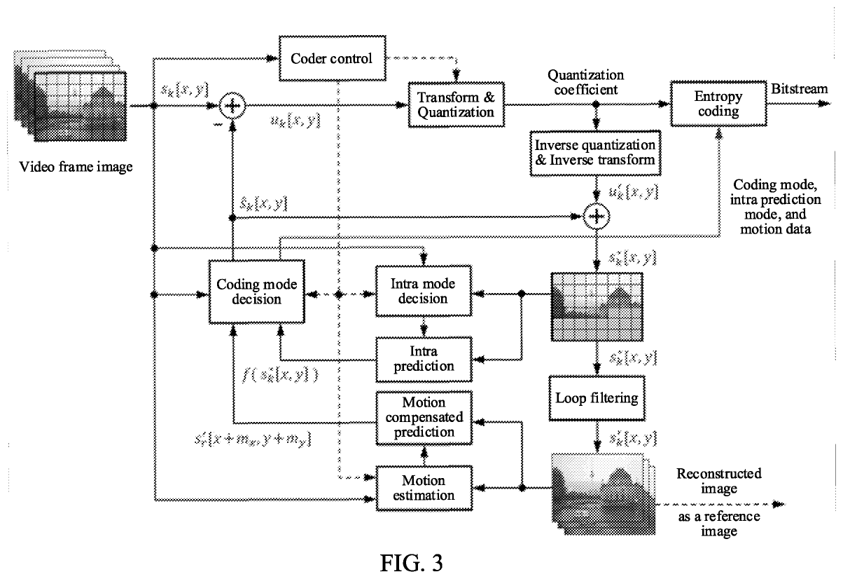

FIG. 3 shows a basic flowchart of a coding process performed by a video coder. In this process, intra prediction is used as an example for description.

A difference operation is performed between an original image signal sₖ[x, y] and a predicted image signal ŝₖ[x, y] to obtain a residual signal uₖ[x, y]. The residual signal uₖ[x, y] is transformed and quantized to obtain a quantization coefficient. The quantization coefficient is subjected to entropy coding to obtain a coded bitstream. In addition, a reconstructed residual signal u′ₖ[x, y] is obtained by inverse quantization and inverse transform. The predicted image signal ŝₖ[x, y] and the reconstructed residual signal u′ₖ[x, y] are superimposed to generate an image signal sₖ*[x, y]. The image signal sₖ*[x, y] is inputted into an intra mode decision module and an intra prediction module for intra prediction processing. In addition, a reconstructed image signal s′ₖ[x, y] is outputted by loop filtering. The reconstructed image signal s′ₖ[x, y] may be used as a reference image of a next frame for motion estimation and motion compensated prediction. Then, a predicted image signal ŝₖ[x, y] of a next frame is obtained based on a result s′ᵣ[x+mₓ, y+m_{y}] of motion compensated prediction and a result f(sₖ*[x, y]) of intra prediction. The foregoing process is repeated continuously until coding is completed.

A coding operation for each CU involved in the foregoing video coding process is described in further detail below.

Predictive coding: The predictive coding includes manners such as intra prediction and inter prediction, and a residual video signal is obtained after an original video signal is predicted from a selected reconstructed video signal. A coder side needs to determine a predictive coding mode selected for the current CU, and inform a decoder side of the predictive coding mode. Intra prediction means that a predicted signal is from a region, on which coding and reconstruction have been performed, of the same image. Inter prediction means that a predicted signal is from another coded image (referred to as a reference image) different from the current image.

Transform & Quantization: After a residual video signal undergoes a transform operation such as discrete Fourier transform (DFT) or discrete cosine transform (DCT), the signal is converted into a transform domain, which is referred to as a transform coefficient. Lossy quantization is further performed on the transform coefficient, to lose some information, so that a quantized signal is beneficial to compression and expression. In some video coding standards, more than one transform manner may be selected. Therefore, the coder side also needs to select one transform manner for the current CU, and inform the decoder side of the transform manner. Quantization fineness can be determined by a quantization parameter (QP). A larger QP value indicates that coefficients within a larger value range are quantized to the same output. Therefore, a larger distortion and a lower bit rate can be caused. On the contrary, a relatively small QP value indicates that coefficients in a relatively small value range are quantized into the same output. Therefore, a relatively small distortion can be caused, and a corresponding relatively high bit rate is also caused.

Entropy coding or statistical coding: Statistical compression and coding are performed on a quantized transform domain signal according to an occurrence frequency of each value, and finally a binary (0 or 1) compressed bitstream is outputted. Meanwhile, other information, such as a selected coding mode and motion vector data, is generated through coding, and entropy coding also needs to be performed to reduce a code rate. Statistical coding is a lossless coding manner, and can effectively reduce a code rate required for expressing the same signal. A common statistical coding manner includes variable length coding (VLC) or content adaptive binary arithmetic coding (CABAC).

A CABAC process can include three operations: binarization, context modeling, and binary arithmetic coding. After an input syntactic element is binarized, binary data may be coded by using a related coding mode and a bypass coding mode. In the bypass coding mode, it is unnecessary to allocate a particular probability model to each binary bit, and an input binary bit bin value is directly coded by using a simple bypass coder, to accelerate entire coding and decoding. For example, different syntactic elements are not completely independent of each other, and the same syntactic element also has some memorization. Therefore, according to a conditional entropy theory, conditional coding is performed by using another coded syntactic element, and the coding performance can be further improved compared with independent coding or memoryless coding. The coded sign information used as a condition is referred to as a context. In the related coding mode, binary bits of a syntactic element sequentially enter a context model. The coder allocates an appropriate probability model to each input binary bit according to a previously coded syntactic element or a value of a binary bit. This process is context modeling. A context model corresponding to the syntactic element may be located by using a context index increment (ctxIdxInc) and a context index start (ctxIdxStart). After the bin value and the allocated probability model are both transmitted to the binary arithmetic coder for coding, the context model needs to be updated according to the bin value. This is an adaptation process during coding.

Loop filtering: A reconstructed image is obtained by performing operations of inverse quantization, inverse transform, and predicted compensation on a signal after change and quantization. The reconstructed image has quantization impact compared with the original image, and some information is different from the original image. For example, the reconstructed image may be distorted. Therefore, a filtering operation may be performed on the reconstructed image by using, for example, a filter such as a deblocking filter (DB), a sample adaptive offset (SAO), or an adaptive loop filter (ALF), to effectively reduce a distortion degree generated by quantization. Since these filtered reconstructed images are used as reference for subsequent coded images to predict a future image signal, the foregoing filtering operation is also referred to as loop filtering, namely a filtering operation in a coding loop.

Based on the foregoing coding process, after a compressed bitstream (i.e., a bitstream) is obtained for each CU at the decoder side, entropy decoding is performed to obtain various mode information and quantization coefficients. Then, inverse quantization and inverse transform processing are performed on the quantization coefficient to obtain a residual signal. In addition, a predicted signal corresponding to the CU may be obtained according to known coding mode information, and then a reconstructed signal may be obtained after the residual signal and the predicted signal are added. The reconstructed signal is then subjected to an operation such as loop filtering, to generate a final output signal.

In the related art, correlations between residual values obtained through prediction for a current block and a reference region may be different. For example, when original values (i.e., original pixel values) of the current block are relatively close to the reference region, a correlation between the residual values obtained through prediction and the reference region is relatively high. When the original values of the current block are relatively far from the reference region, a correlation between the residual values obtained through prediction and the reference region is relatively low. Consequently, losses generated through quantization are not evenly distributed, thereby reducing accuracy and efficiency of current block reconstruction, and low reliability of video coding/decoding.

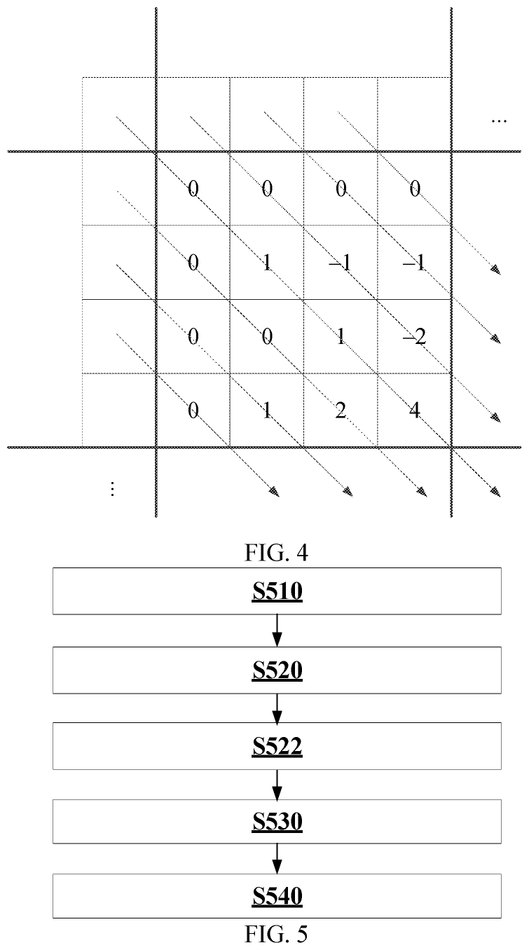

As shown in FIG. 4, a current block is a region shown by a shadow, and a reference region is an image region located above and to the left of the current block. The upper and left image regions in the current block are relatively close to the reference region, and a residual absolute value generated through prediction is relatively small. The lower and right image region in the current block are relatively far from the reference region, and a residual absolute value generated through prediction is relatively large (a maximum value of 4 at a lower right corner). In a subsequent quantization process, losses to the upper and left image regions in the current block are relatively small, and losses to the lower and right image regions in the previous block are relatively large.

Therefore, to improve accuracy and efficiency of current block reconstruction and help ensure reliability of video coding/decoding, an aspect of this disclosure provides a video coding/decoding solution. A coder side may obtain a predictive coding mode corresponding to a current block. The current block is a to-be-decoded image block in a current video frame. If the predictive coding mode is intra prediction, residual correction information corresponding to the current block is generated, and the residual correction information corresponding to the current block is transmitted to a decoder side. Correspondingly, the decoder side receives the residual correction information corresponding to the current block, determines a to-be-corrected residual value corresponding to the current block, corrects the to-be-corrected residual value based on the residual correction information, to obtain a corrected residual value, and then obtains a reconstructed value of the current block based on the corrected residual value.

In this way, by implementing the aspects of this disclosure, when it is detected that a current block is in intra prediction, residual correction information corresponding to the current block is generated, and a to-be-corrected residual value corresponding to the current block is corrected by using the residual correction information, thereby avoiding a phenomenon of uneven quantization loss caused by different correlations between residual values and a reference region, improving accuracy and efficiency of current block reconstruction, and improving reliability of video coding/decoding.

FIG. 5 shows a flowchart of a video decoding method according to an aspect of this disclosure. The video decoding method may be performed by an electronic device, for example, a terminal device or a server that transmits or receives video coding data. This aspect of this disclosure is described by taking a method performed by a terminal device as an example. The terminal device may be, for example, the video decoding apparatus 210 or the video coding apparatus 203 shown in FIG. 2. As shown in FIG. 5, the video decoding method includes at least S510 to S540.

S510: Obtain, from a bitstream, residual correction information corresponding to a current block.

The current block is an intra-coded image block in a current video frame. The residual correction information is generated by a coder side when a predictive coding mode corresponding to the current block is intra prediction, and is coded into a video bitstream corresponding to the current video frame.

In the aspects of this disclosure, the image block is a basic unit for decoding, and includes, but is not limited to, at least one of a coding unit, a luminance coding unit, a chrominance coding unit, a coding block, a luminance coding block, a chrominance coding block, a prediction unit, a luminance prediction unit, a chrominance prediction unit, a luminance prediction block, or a chrominance prediction block.

In the aspects of this disclosure, the residual correction information is configured for correcting a to-be-corrected residual value corresponding to the current block, and obtaining a reconstructed value of the current block according to the corrected residual value. In other words, the residual correction information is configured for correcting a to-be-corrected residual value corresponding to the current block and reconstructing the current block according to the corrected residual value. The current block may be reconstructed by a decoder side or may be performed by the coder side (e.g., a local decoder in a coder). Meanwhile, the residual correction information may be generated by the coder side when the predictive coding mode corresponding to the current block is intra prediction. For a generation process of the residual correction information, refer to the following description.

S520: Determine a to-be-corrected residual value corresponding to the current block.

Not all residual values in the current block need to be adjusted. In the aspects of this disclosure, the residual correction information corresponding to the current block is obtained, and then the to-be-corrected residual value may be determined from the current block.

In the aspects of this disclosure, the to-be-corrected residual value is a residual value that needs to be corrected. There may be one or more to-be-corrected residual values.

S522: Decode a correction value from the residual correction information.

In the aspects of this disclosure, the residual correction information in the bitstream is not a correction value for correcting a residual value, but is a result obtained after the correction value is coded. The residual correction information needs to be decoded, to restore an actual correction value. A coding method used by the correction value may be any feasible mapping method or coding algorithm. A data volume of the video bitstream is reduced and transmission efficiency is improved by reducing a data volume of the coded correction value.

In the aspects of this disclosure, when the correction value is decoded from the residual correction information, a bit string may be decoded from the residual correction information, and a value corresponding to the bit string in a preset mapping relationship is determined. In some aspects, the value corresponding to the bit string in the preset mapping relationship is a correction value. In some other aspects, when a sign and an absolute value of the correction value are respectively coded, the value corresponding to the bit string in the preset mapping relationship may be determined as the absolute value of the correction value.

In the aspects of this disclosure, the sign and the absolute value of the correction value may be coded and transmitted respectively. When the residual correction information is decoded, the sign of the correction value may be decoded from sign information in the residual correction information, and the absolute value of the correction value may be decoded from value information in the residual correction information. For example, a bit string may be decoded from the value information in the residual correction information, and then a value corresponding to the bit string is determined as the absolute value of the correction value.

In the aspects of this disclosure, the bit string corresponding to the correction value may be coded by using a context-based coding algorithm, to further reduce the number of bits needed for transmission of the correction value. When a bit string is decoded from the residual correction information, context information may be generated by using the bit string corresponding to an adjustment value of at least one previously decoded block, and the bit string is decoded from the residual correction information based on the context information by using a preset context model-based coding algorithm.

S530: Correct at least one residual value of the current block by using the correction value to obtain a corrected residual value.

In this operation, the to-be-corrected residual value is corrected according to the residual correction information, to obtain the corrected residual value.

In the aspects of this disclosure, the to-be-corrected residual value corresponding to the current block is determined, and then the to-be-corrected residual value may be corrected by using the residual correction information, to obtain the corrected residual value.

In the aspects of this disclosure, a correction value may be decoded from a bitstream, and a plurality of different correction values are derived in a preset manner, to correct residual values corresponding to different positions in the current block. For example, a residual value corresponding to a first preset position in the current block may be corrected by using the correction value. A plurality of second correction values corresponding to a plurality of second preset positions in the current block are derived by using the correction value, and residual values corresponding to the plurality of second preset positions are corrected by using the plurality of second correction values.

In the aspects of this disclosure, the manner of deriving a plurality of second correction values by using the correction value may be: calculating a product of the correction value and a correction coefficient corresponding to each second preset position among the plurality of second preset positions respectively as the second correction value.

In some aspects, the correction coefficient may be pre-stored in an accessible storage device. When the second correction value is generated, the pre-stored correction coefficient may be obtained.

In some aspects, the correction coefficient may be determined by a coding device and coded into a bitstream. When the second correction value is generated, the correction coefficient may be decoded from the bitstream.

When an intra prediction mode is used and a quantization step is relatively large (a corresponding quantization parameter is relatively large), a loss generated during quantization at each position in the current block is related to a distance to a reference region. In the aspects of this disclosure, the correction coefficient corresponding to a second preset position is positively correlated with a distance between the second preset position and a reference region. The reference region is a decoded image region for intra prediction of the current block. In this way, different correction coefficients are set according to a difference of the distance between each position in the current block and the reference region, and the second correction value corresponding to each position is derived, so that residual values at different positions may be corrected in a targeted manner, distortion caused by quantization can be reduced, a reconstructed image is more visually natural, and accuracy of video decoding is improved.

In some aspects, an absolute value of the corrected residual value is less than an absolute value of the residual value before correction. For example, the residual value before correction is set to R, and the to-be-corrected residual value R is corrected according to the residual correction information to obtain a corrected residual value R′. In this case, |R′|<|R|.

In this way, a residual value participating in the current block reconstruction is smaller, and the accuracy and efficiency of current block reconstruction are higher, thereby improving the accuracy and efficiency of decoding.

In the aspects of this disclosure, if a plurality of to-be-corrected residual values are included, distribution consistency of the plurality of corrected residual values is greater than distribution consistency of the plurality of corrected residual values before correction. For example, it is set that the distribution consistency of the plurality of residual values before correction is Rc, the plurality of to-be-corrected residual values are corrected according to the residual correction information to obtain a plurality of corrected residual values, and distribution consistency of the plurality of corrected residual values is Rc′. In this case, Rc′>Rc. The distribution consistency is in direct proportion to the regularity. For example, a higher distribution consistency indicates a higher regularity. Otherwise, a lower distribution consistency indicates a lower regularity.

In this way, the distribution consistency of a residual value participating in the current block reconstruction is higher, and the accuracy and efficiency of current block reconstruction are higher, thereby improving the accuracy and efficiency of decoding.

S540: Reconstruct the current block by using the corrected residual value, to obtain a reconstructed value of the current block.

In the aspects of this disclosure, the corrected residual value is obtained, and then the reconstructed value of the current block may be obtained by using the corrected residual value, to reconstruct the current block.

In the aspects of this disclosure, the process of obtaining a reconstructed value of the current block according to the corrected residual value in S540 may include:
obtaining a predicted value of the current block; and
calculating a reconstructed value of the current block according to the predicted value and the corrected residual value.

For example, the reconstructed value of the current block is calculated by using the predicted value and the corrected residual value of the current block.

For example, Pred(i,j) represents a predicted value corresponding to a position (i, j) in a current block, Res(i,j) represents a residual value obtained after inverse transform of the position (i, j) of the current block, and Adj represents a correction value. Then, a reconstructed value of the position (i, j) of the current block is Rec(i,j)=Pred(i,j)+Res(i,j)+Adj.

In this way, the reconstructed value of each position in the current block can be easily and accurately obtained.

In the aspects of this disclosure, a to-be-corrected residual value corresponding to a current block is corrected by using residual correction information, thereby avoiding a phenomenon of uneven quantization loss caused by different correlations between residual values and a reference region, improving accuracy and efficiency of current block reconstruction, and improving reliability of video coding/decoding.

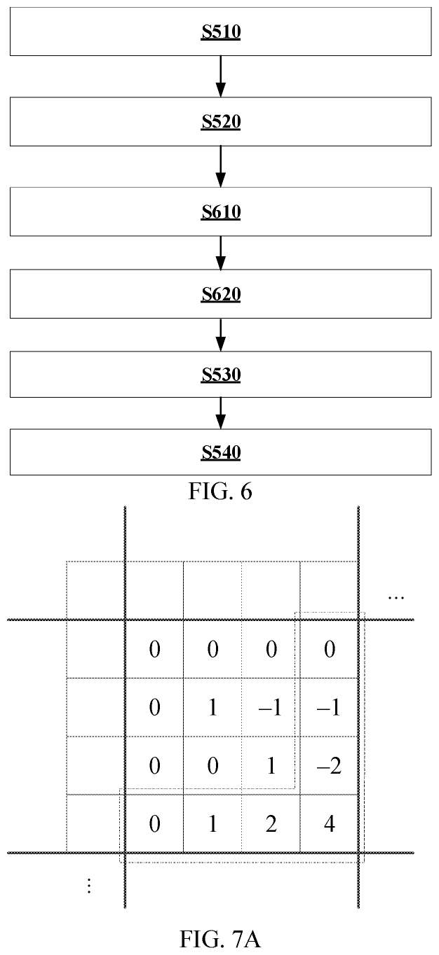

In an aspect of this disclosure, another video decoding method is provided. The video decoding method may be performed by an electronic device, for example, a terminal device or a server that transmits or receives video coding data. This aspect of this disclosure is described by taking a method performed by a terminal device as an example. The terminal device may be, for example, the video decoding apparatus 210 or the video coding apparatus 203 shown in FIG. 2. As shown in FIG. 6, the video decoding method includes at least S610 to S620, S510, S522, and S530 to S540.

S610: Select a to-be-corrected region from a current block. The to-be-corrected region is agreed by a coder side and a decoder side, and the to-be-corrected region includes at least one of a lower image region in the current block and a right image region in the current block.

In the aspects of this disclosure, the to-be-corrected region refers to an image region on which residual value correction needs to be performed. The to-be-corrected region is agreed by the coder side and the decoder side.

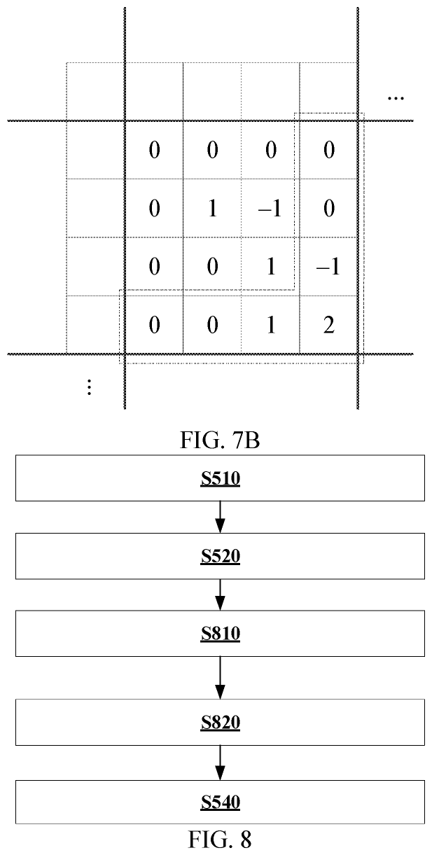

As mentioned in the foregoing aspects, the upper and left image regions in the current block are relatively close to the reference region, and a residual absolute value generated through prediction is relatively small. The lower and right image regions in the current block are relatively far from the reference region, and a residual absolute value generated through prediction is relatively large. Therefore, in the aspects, the to-be-corrected region may be the lower and/or right image regions in the current block. As shown in FIG. 7A, the to-be-corrected region is the lower and right image regions in the current block shown by a dashed line box.

S620: Determine a to-be-corrected residual value from a plurality of residual values included in the to-be-corrected region.

In the aspects of this disclosure, the to-be-corrected region is selected from the current block, and then the to-be-corrected residual value may be determined from the plurality of residual values included in the to-be-corrected region.

In the aspects of this disclosure, the process of determining a to-be-corrected residual value from a plurality of residual values included in the to-be-corrected region in S620 may include:
selecting a non-zero residual value from the plurality of residual values included
in the to-be-corrected region; and
taking the non-zero residual value as a to-be-corrected residual value.

For example, a non-zero residual value is selected from the plurality of residual values included in the to-be-corrected region. In this case, the non-zero residual value is the to-be-corrected residual value. As shown in FIG. 7A, residual values 1, 2, 4, −2, and −1 in lower and right image regions of a current block shown by dashed line boxes are to-be-corrected residual values.

In this way, non-zero residual values in the to-be-corrected region are used as the to-be-corrected residual values, so as to avoid correcting a residual value that is zero, thereby improving accuracy of residual value correction.

For detailed description of S510, S522, S530, and S540 shown in FIG. 6, refer to S510, S522, S530, and S540 shown in FIG. 5. Details are not described herein again.

In the aspects of this disclosure, the to-be-corrected region is selected from the current block, and the to-be-corrected residual value is determined from the plurality of residual values included in the to-be-corrected region, so that the to-be-corrected residual value can be easily and accurately obtained, thereby providing strong support for residual value correction.

In an aspect of this disclosure, another video decoding method is provided. The video decoding method may be performed by an electronic device, for example, a terminal device or a server that transmits or receives video coding data. This aspect of this disclosure is described by taking a method performed by a terminal device as an example. The terminal device may be, for example, the video decoding apparatus 210 or the video coding apparatus 203 shown in FIG. 2. As shown in FIG. 8, the video decoding method includes at least S810 to S820, S510 to S520, and S540.

S810: Extract a correction coding result from residual correction information, and decode the correction coding result, to obtain a correction value.

In the aspects of this disclosure, the residual correction information corresponding to the current block is obtained, and then the correction coding result may be extracted from the residual correction information. There may be one or more correction coding results, and the correction coding result is decoded, to obtain the correction value.

In the aspects of this disclosure, the correction value includes a correction sign and a correction absolute value. The correction sign is positive or negative. The correction absolute value can be an integer, and a value range of the correction absolute value may be [0, N]. For example, the correction coding result may be obtained by performing fixed-length coding on the correction absolute value by using M bits, for example, N=2^{M}.

In the aspects of this disclosure, a plurality of correction coding results are extracted. Correspondingly, the process of decoding the corrected coding result to obtain a correction value in S810 may include:
obtaining a mapping relationship between a correction value and a correction coding result, the mapping relationship between a correction value and a correction coding result including a plurality of correction values and correction coding results respectively corresponding to the plurality of correction values, and correction coding results corresponding to different correction values having different coding lengths; and
obtaining a correction value corresponding to each extracted correction coding result according to the mapping relationship between a correction value and a correction coding result.

For example, after the plurality of correction coding results are extracted, the mapping relationship between a correction value and a correction coding result may be obtained, and the correction value corresponding to each correction coding result is obtained by querying the mapping relationship between a correction value and a correction coding result.

The mapping relationship between a correction value and a correction coding result is stored in a specified storage region of the decoder side. The stored mapping relationship is agreed by the coder side and the decoder side. Therefore, the mapping relationship between a correction value and a correction coding result can be obtained from the specified storage region.

The mapping relationship between a correction value and a correction coding result includes a plurality of correction values and correction coding results respectively corresponding to the plurality of correction values, and correction coding results corresponding to different correction values have different coding lengths. The correction value includes a correction sign and a correction absolute value. The mapping relationship between a correction value and a correction coding result may be a mapping relationship between a correction absolute value and a correction coding result (i.e., the value information in the residual correction information). For example, the mapping relationship between a correction absolute value and a correction coding result includes correction absolute values and correction coding results respectively corresponding to the plurality of correction absolute values. Correction coding results corresponding to different correction absolute values have different coding lengths.

Table 1 shows an example table of a mapping relationship between a correction absolute value and a correction coding result.

TABLE 1

| Correction absolute | | | | | |
|---|---|---|---|---|---|
| value | 1 | 2 | 4 | 6 | 8 |
| Correction coding result | 10 | 110 | 1110 | 11110 | 11111 |

In an actual application, the mapping relationship between a correction absolute value and a correction coding result may be flexibly adjusted according to a specific application scenario.

In this way, according to the mapping relationship between a correction value and a correction coding result, the correction value corresponding to each correction coding result can be easily and accurately obtained.

In the aspects of this disclosure, before obtaining a mapping relationship between a correction value and a correction coding result, a coding device or a decoding device may further perform the following operations:
coding the plurality of generated correction values according to a VLC policy, to generate a correction coding result corresponding to each correction value; and
associating this correction value with the correction coding result corresponding to this correction value, and generating a mapping relationship between a correction value and a correction coding result.

For example, the plurality of generated correction values are coded according to a VLC policy, to generate a correction coding result corresponding to each correction value, and each correction value is associated with the correction coding result corresponding to each correction value, thereby generating a mapping relationship between a correction value and a correction coding result.

In this way, coding the correction value by using the VLC policy is beneficial to reducing signaling overhead.

In the aspects of this disclosure, the process in which the coding device or the decoding device codes the plurality of generated correction values according to a VLC policy, to generate a correction coding result corresponding to each correction value may include:
collecting statistics on a plurality of correction values generated by a historical block, to obtain an occurrence count of the same correction value;
determining a coding length of each correction value according to the occurrence count, the occurrence count being inversely proportional to the coding length; and
coding this correction value according to the coding length of this correction value, to obtain a correction coding result corresponding to this correction value, or decoding the correction coding result to obtain the corresponding correction value.

For example, the occurrence count of the same correction value generated for a historical block may be obtained through statistics in advance, a coding length of each correction value is determined according to the occurrence count, and then each correction value is coded according to the coding length of each correction value, to obtain a correction coding result corresponding to each correction value.

The historical block refers to a decoded image block in the current video frame, and includes, but is not limited to, a decoded image block that is most adjacent to and/or next adjacent to the current block. In an actual application, the historical block may be flexibly selected according to a specific application scenario.

The occurrence count of the same correction value is inversely proportional to the coding length of the correction value. For example, a larger occurrence count of the same correction value indicates a smaller coding length; otherwise, a smaller occurrence count of the same correction value indicates a larger coding length.

Table 2 shows an example table of a mapping relationship between an occurrence count and a coding length.

TABLE 2

| Occurrence count | 100 | 80 | 60 | 40 | 50 |
|---|---|---|---|---|---|
| Coding length | 2 | 3 | 4 | 5 | 6 |

In an actual application, the mapping relationship between an occurrence count and a coding length may be flexibly adjusted according to a specific application scenario.

In this way, the coding length of the correction value is determined by using the occurrence count, and coding is performed correspondingly, so that the coding of the correction value is more proper and flexible, and the signaling overhead is reduced.

In the aspects of this disclosure, the correction coding result corresponding to the absolute value (a correction absolute value for short) of the correction value may be obtained by using CABAC. For example, a w^{th} bit of a correction coding result of a correction absolute value of a current block position is determined by using w^{th} bits of correction coding results of correction absolute values respectively corresponding to a plurality of historical block positions.

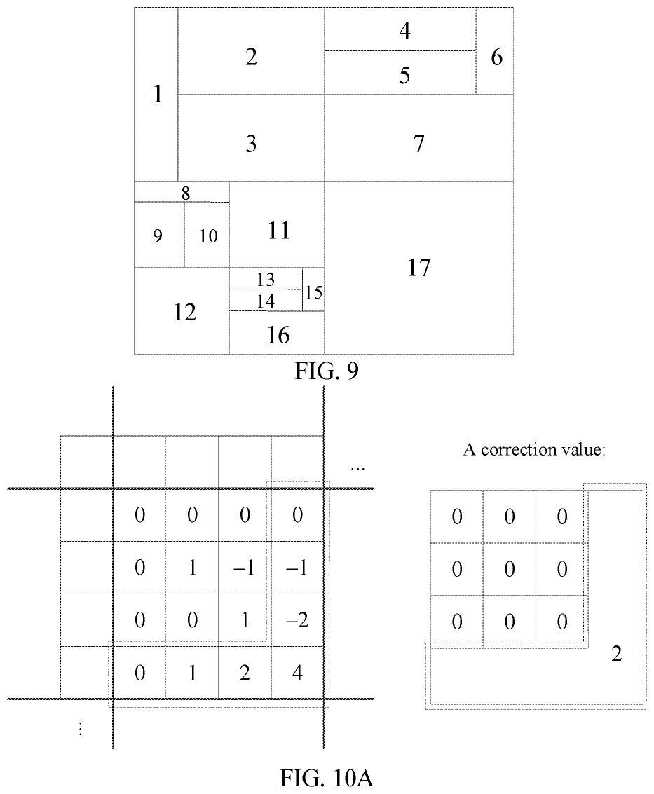

As shown in FIG. 9, a coding order of each image block is identified. For example, for image block 3, a w^{th} bit of a correction coding result corresponding to a correction absolute value at a position thereof is determined according to a w^{th} bit of a correction coding result corresponding to a correction absolute value at the same position of image block 1 and a w^{th} bit of a correction coding result corresponding to a correction absolute value at the same position of image block 2. The CABAC at the w^{th} bit of the correction coding result corresponding to the correction absolute value at the particular position may be represented as z=x+y (z=0, 1, 2). Case 1: When z=0, values of the w^{th} bits of the correction coding results corresponding to the correction absolute values of image block 1 and image block 2 are both 0. Case 2: When z=1, values of the w^{th} bits of the correction coding results corresponding to the correction absolute values of image block 1 and image block 2 are 0 and 1, respectively. Case 3: When z=2, values of the w^{th} bits of the correction coding results corresponding to the correction absolute values of image block 1 and image block 2 are both 1.

In this way, coding is performed correspondingly by using the CABAC, so that the coding of the correction value is more proper and flexible.

In the aspects of this disclosure, the process of obtaining a correction value corresponding to each extracted correction coding result according to the mapping relationship between a correction value and a correction coding result may include:
obtaining a correction identifier corresponding to each extracted correction coding result according to a mapping relationship between a correction identifier and a correction coding result; and
obtaining a correction value corresponding to each correction identifier according to the mapping relationship between a correction identifier and a correction value.

For example, a mapping relationship between a correction identifier and a correction coding result is queried to obtain a correction identifier corresponding to each correction coding result, and then a mapping relationship between a correction identifier and a correction value is queried to obtain a correction value corresponding to each correction identifier, thereby obtaining the correction value corresponding to each correction coding result.

The mapping relationship between a correction value and a correction coding result may include the mapping relationship between a correction identifier and a correction value, and the mapping relationship between a correction identifier and a correction coding result.

For example, the mapping relationship between a correction identifier and a correction value includes a plurality of correction identifiers and correction values respectively corresponding to the plurality of correction identifiers. Similarly, since the correction value includes a correction sign and a correction absolute value, the mapping relationship between a correction identifier and a correction value is essentially the mapping relationship between a correction identifier and a correction absolute value. For example, the mapping relationship between a correction identifier and a correction absolute value includes correction identifiers and correction absolute values respectively corresponding to the plurality of correction identifiers. The correction identifier is configured for uniquely identifying the correction value.

Table 3 shows an example table of a mapping relationship between a correction identifier and a correction absolute value.

TABLE 3

| Correction identifier | 1 | 2 | 3 | 4 | 5 |
|---|---|---|---|---|---|
| Correction absolute value | 1 | 2 | 4 | 6 | 8 |

In an actual application, the mapping relationship between a correction identifier and a correction absolute value may be flexibly adjusted according to a specific application scenario.

The mapping relationship between a correction identifier and a correction coding result includes a plurality of correction identifiers and correction coding results respectively corresponding to the plurality of correction identifiers, and correction coding results corresponding to different correction identifiers have different coding lengths.

Table 4 shows an example table of a mapping relationship between a correction identifier and a correction coding result.

TABLE 4

| Correction identifier | 1 | 2 | 3 | 4 | 5 |
|---|---|---|---|---|---|
| Correction coding result | 10 | 110 | 1110 | 11110 | 11111 |

In an actual application, the mapping relationship between a correction identifier and a correction coding result may be flexibly adjusted according to a specific application scenario.

The mapping relationship between a correction identifier and a correction value and the mapping relationship between a correction identifier and a correction coding result may be in the same table. In an actual application, flexible adjustment may be performed according to a specific application scenario.

In this way, by introducing correction identifiers, more accurate and ordered correction coding results can be obtained, thereby better implementing the coding of the correction value.

S820: Correct a plurality of to-be-corrected residual values respectively according to the correction value, to obtain a plurality of corrected residual values.

In the aspects of this disclosure, a correction value is obtained, and then a plurality of to-be-corrected residual values may be respectively corrected by using the correction value, to obtain a plurality of corrected residual values.

Continuing the foregoing example in FIG. 7A, residual values 1, 2, 4, −2, and −1 in lower and right image regions in a current block shown by dashed line boxes in the current block are respectively corrected. For example, 1 is corrected to be 0, 2 is corrected to be 1, 4 is corrected to be 2, −2 is corrected to be −1, and −1 is corrected to be 0, thereby obtaining a plurality of corrected residual values shown in FIG. 7B.

In the aspects of this disclosure, the process of correcting a plurality of to-be-corrected residual values respectively according to the correction value, to obtain a plurality of corrected residual values in S820 may include at least two cases:

Case 1: Sum, if a correction value is obtained through decoding, the correction value with each residual value, to obtain a plurality of corrected residual values.

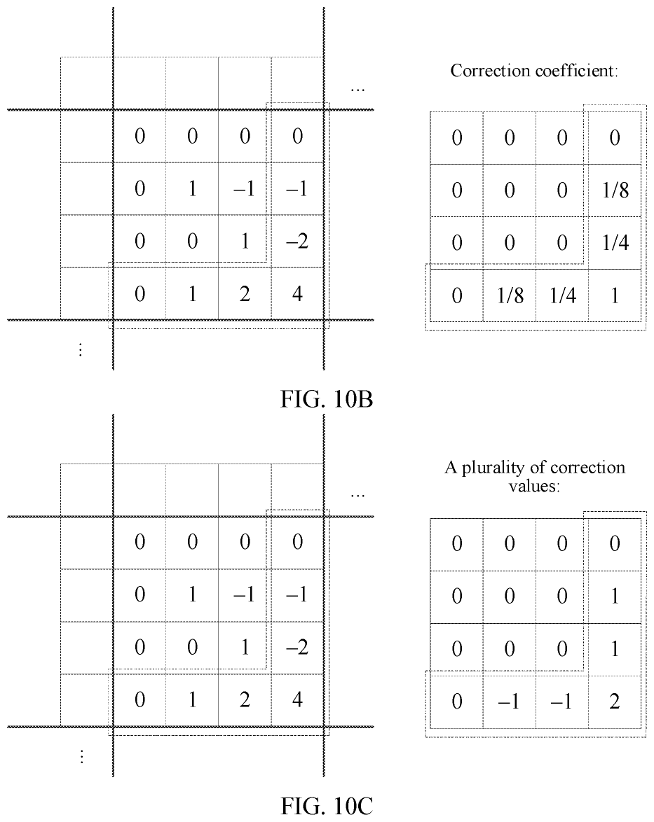

For example, in a case where the correction coding result is decoded to obtain a correction value, the correction value may be summed with each residual value, to obtain each corrected residual value. As shown in FIG. 10A, dashed line boxes show a correction value 2 and a plurality of to-be-corrected residual values 1, 2, 4, −2, and −1, and the correction value 2 is summed with each of the residual values 1, 2, 4, −2, and −1, to obtain each corrected residual value.

In the aspects of this disclosure, the summing the correction value with each residual value, to obtain a plurality of corrected residual values includes:
obtaining, according to a position corresponding to each residual value, a correction coefficient corresponding to each residual value; and
multiplying the correction value by the correction coefficient corresponding to each residual value, to obtain a product operation result corresponding to each residual value, and summing each residual value with the product operation result corresponding to each residual value, to obtain a plurality of corrected residual values.

For example, in the foregoing case 1, a correction coefficient corresponding to each residual value is obtained according to a position corresponding to each residual value. Then, the correction value is multiplied by the correction coefficient corresponding to each residual value, to obtain a product operation result corresponding to each residual value. Then, each residual value is summed with the product operation result corresponding to each residual value, to obtain a plurality of corrected residual values. As shown in FIG. 10B, dashed line boxes show a plurality of correction coefficients ⅛, ¼, 1, ¼, and ⅛, and a plurality of to-be-corrected residual values 1, 2, 4, −2, and −1. The correction value and the correction coefficient at the same position are multiplied, to obtain a product operation result at each position, and the product operation result and the residual value at the same position are summed, to obtain a plurality of corrected residual values.

For example, still using the foregoing example, a correction coefficient corresponding to a current block position (i, j) is represented by alpha(i,j), and then a reconstructed value of the current block position (i, j) is

Rec(i,j)=Pred(i,j)+Res(i,j)+Adj×alpha(i,j).

In this way, when there is only one correction value, the residual value is corrected by using the correction coefficient, and a correction granularity is small, thereby improving correction accuracy.

A plurality of correction coefficients is stored in a specified storage region of the decoder side. The plurality of stored correction coefficients is agreed by the coder side and the decoder side. Therefore, the correction coefficient corresponding to the position of each residual value can be obtained from the specified storage region.

For example, as shown in FIG. 10B, the correction coefficient is directly proportional to a target distance. A larger target distance indicates a larger correction coefficient; otherwise, a smaller target distance indicates a smaller correction coefficient. The target distance refers to a distance between the position of the to-be-corrected residual value in the current block and a reference region. The reference region includes a decoded image region adjacent to the current block, for example, an image region located above and/or to the left of the current block.

In this way, the correction coefficient can be easily and accurately obtained, and the correction coefficient is in direct proportion to the target distance. The accuracy of setting the correction coefficient is high, thereby further improving the correction accuracy.

Case 2: Sum, if a plurality of correction values is obtained through decoding, each correction value with a residual value corresponding to each correction value, to obtain a plurality of corrected residual values.

In a case that the correction coding result is decoded to obtain a plurality of correction values, each correction value may be summed with the residual value corresponding to each correction value, to obtain each corrected residual value. As shown in FIG. 10C, dashed line boxes show a plurality of correction values, −1, −1, 2, 1, and 1 and a plurality of to-be-corrected residual values 1, 2, 4, −2, and −1, and the correction value and the residual value at the same position are summed, to obtain each corrected residual value.

The same position involved in the aspects of this disclosure refers to a position having the same position coordinates in the current block.

For detailed description of S510 to S520 and S540 shown in FIG. 8, refer to S510 to S520 and S540 shown in FIG. 5. Details are not described herein again.

In the aspects of this disclosure, a correction coding result included in residual correction information is decoded, so that a correction value can be easily and accurately obtained, and a to-be-corrected residual value is corrected by using the correction value, thereby improving the accuracy of current block reconstruction.

In an aspect of this disclosure, another video decoding method is provided. The video decoding method may be performed by an electronic device, for example, a terminal device or a server that transmits or receives video coding data. This aspect of this disclosure is described by taking a method performed by a terminal device as an example. The terminal device may be, for example, the video decoding apparatus 210 or the video coding apparatus 203 shown in FIG. 2. As shown in FIG. 11, the video decoding method includes at least S1110 to S1120, and S510 to S530.

S1110: Determine another residual value other than a corrected residual value in a current block.

In the aspects of this disclosure, another residual value other than the corrected residual value is determined from the current block. There may be one or more other residual values.

S1120: Obtain a reconstructed value of the current block according to the another residual value, the corrected residual value, and a predicted value corresponding to the current block.

In the aspects of this disclosure, another residual value is obtained, and then the reconstructed value of the current block may be calculated by using the another residual value, the corrected residual value, and the predicted value corresponding to the current block.

In the aspects of this disclosure, the process of obtaining a reconstructed value of the current block according to the another residual value, the corrected residual value, and a predicted value corresponding to the current block in S1120 may include:
summing the predicted value and the another residual value at the same position, and summing the predicted value and the corrected residual value at the same position, to obtain the reconstructed value of each position of the current block.

For example, the predicted value and the another residual value at the same position are summed, and the predicted value and the corrected residual value at the same position are summed, to obtain the reconstructed value of each position of the current block.

In this way, the reconstructed value of each position in the current block can be easily and accurately obtained.

For detailed description of S510 to S530 shown in FIG. 11, refer to S510 to S530 shown in FIG. 5. Details are not described herein again.

In the aspects of this disclosure, the reconstructed value of the current block can be easily and accurately calculated by using the corrected residual value, the predicted value, and another residual value other than the corrected residual value, thereby implementing reconstruction of the current block.

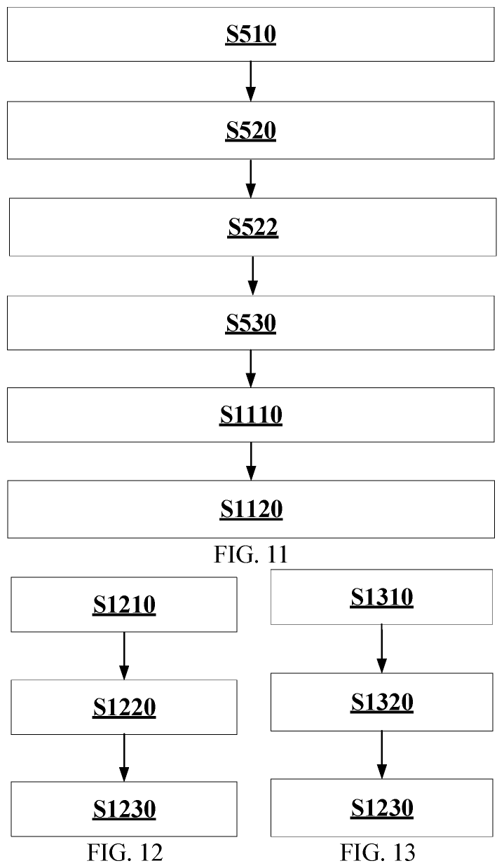

FIG. 12 shows a flowchart of a video coding method according to an aspect of this disclosure. The video coding method may be performed by an electronic device, for example, a terminal device or a server that transmits video coding data. This aspect of this disclosure is described by taking a method performed by a terminal device as an example. The terminal device may be, for example, the video coding apparatus 203 shown in FIG. 2. As shown in FIG. 12, the video coding method includes at least S1210 to S1230.

S1210: Generate, in response to determining that a predictive coding mode corresponding to a to-be-coded current block in a video image is intra prediction, a correction value corresponding to the current block.

In this operation, a predictive coding mode corresponding to a current block may be obtained. The current block is a to-be-decoded image block in a current video frame.

In the aspects of this disclosure, the predictive coding mode corresponding to the current block may be obtained, to detect whether the predictive coding mode corresponding to the current block is intra prediction or inter prediction.

A coding device may generate the correction value of the current block based on a preset rule. In the aspects of this disclosure, the correction value may be determined according to various coding parameters and information about a current image or the current block. For example, the correction value may be determined according to at least one of the following: a quantization parameter of the current block, a residual value in the current block, a residual value of a coded block in the current image, or the like.

S1220: Code the correction value into residual correction information.

If the predictive coding mode is intra prediction, residual correction information corresponding to the current block is generated, where the residual correction information is configured for correcting a to-be-corrected residual value corresponding to the current block, and obtaining a reconstructed value of the current block according to the corrected residual value.

S1230: Code the residual correction information into a coded video bitstream corresponding to the video image.

In the aspects of this disclosure, the manner of coding the correction value into residual correction information may include: determining a bit string corresponding to the correction value in a preset mapping relationship; and coding the bit string into the residual correction information.

In the aspects of this disclosure, the manner of coding the correction value into residual correction information may include: coding a sign of the correction value into sign information in the residual correction information; and coding an absolute value of the correction value into value information in the residual correction information. For example, a bit string corresponding to the absolute value of the correction value in the preset mapping relationship may be determined. The bit string is coded into the value information in the residual correction information.

In the aspects of this disclosure, the manner of coding the bit string into the residual correction information includes: generating context information by using a bit string corresponding to an adjustment value of at least one previously coded block; and coding the bit string into the value information based on the context information by using a preset context model-based coding algorithm.

In the aspects of this disclosure, when it is detected that the predictive coding mode corresponding to the current block is intra prediction, residual correction information corresponding to the current block may be generated, where the residual correction information is configured for correcting a to-be-corrected residual value corresponding to the current block, and obtaining a reconstructed value of the current block according to the corrected residual value. The residual correction information is configured for correcting a to-be-corrected residual value corresponding to the current block and reconstructing the current block according to the corrected residual value. The current block may be reconstructed by the decoder side or the coder side. For the reconstruction process of the current block, refer to the foregoing description.

In the aspects of this disclosure, when it is detected that a current block is in intra prediction, residual correction information corresponding to the current block is generated, so that a to-be-corrected residual value corresponding to the current block may be corrected by using the residual correction information, thereby avoiding a phenomenon of uneven quantization loss caused by different correlations between residual values and a reference region, improving accuracy and efficiency of current block reconstruction, and improving reliability of video coding/decoding.

In an aspect of this disclosure, another video coding method is provided. The video coding method may be performed by an electronic device, for example, a terminal device or a server that transmits video coding data. This aspect of this disclosure is described by taking a method performed by a terminal device as an example. The terminal device may be, for example, the video coding apparatus 203 shown in FIG. 2. As shown in FIG. 13, the video coding method includes at least S1310 to S1320, and S1230.

S1310: Determine a to-be-corrected residual value corresponding to a current block, and generate a correction value corresponding to the to-be-corrected residual value.

In the aspects of this disclosure, a to-be-corrected residual value corresponding to a current block may be first determined, and there may be one or more to-be-corrected residual values, to generate a correction value corresponding to the to-be-corrected residual value.

In the aspects of this disclosure, the correction value includes a correction sign and a correction absolute value. The correction sign is positive or negative. The correction absolute value can be an integer, and a value range of the correction absolute value may be [0, N]. For example, the correction coding result may be obtained by performing fixed-length coding on the correction absolute value by using M bits, for example, N=2^{M}.

In the aspects of this disclosure, the process of determining a to-be-corrected residual value corresponding to a current block in S1310 may include:
selecting a to-be-corrected region from the current block, the to-be-corrected region being agreed by the coder side and the decoder side, and the to-be-corrected region including at least one of a lower image region in the current block and a right image region in the current block; and
determining a to-be-corrected residual value from a plurality of residual values included in the to-be-corrected region.

For example, the to-be-corrected residual value is determined from the plurality of residual values included in the to-be-corrected region of the current block.

The to-be-corrected region refers to an image region on which residual value correction needs to be performed. The to-be-corrected region is agreed by the coder side and the decoder side.

As mentioned in the foregoing aspects, the upper and left image regions in the current block are relatively close to the reference region, and a residual absolute value generated through prediction is relatively small. The lower and right image region in the current block are relatively far from the reference region, and a residual absolute value generated through prediction is relatively large. Therefore, the to-be-corrected region may be a lower or right image region in the current block. For example, refer to FIG. 7A again.

In this way, the to-be-corrected region is selected from the current block, and the to-be-corrected residual value is determined from the plurality of residual values included in the to-be-corrected region, so that the to-be-corrected residual value can be easily and accurately obtained, thereby providing strong support for residual value correction.

In the aspects of this disclosure, the process of determining a to-be-corrected residual value from a plurality of residual values included in the to-be-corrected region may include:
selecting a non-zero residual value from the plurality of residual values included in the to-be-corrected region; and
taking the non-zero residual value as a to-be-corrected residual value.

For example, a non-zero residual value is selected from the plurality of residual values included in the to-be-corrected region. In this case, the non-zero residual value is the to-be-corrected residual value. For example, refer to FIG. 7A again.

In this way, non-zero residual values in the to-be-corrected region are used as the to-be-corrected residual values, so as to avoid correcting a residual value that is zero, thereby improving accuracy of residual value correction.

In the aspects of this disclosure, there are a plurality of to-be-corrected residual values. Correspondingly, the process of generating a correction value corresponding to the to-be-corrected residual value in S1310 may include one of at least two manners:

Manner 1: Generate a correction value for a plurality of to-be-corrected residual values.

For example, only one correction value may be generated for a plurality of to-be-corrected residual values. For example, refer to FIG. 10A again.

The process of generating a correction value for a plurality of to-be-corrected residual values in manner 1 may include: selecting, for a plurality of to-be-corrected residual values from a plurality of candidate correction values, a correction value enabling maximum overall reduction or maximum overall distribution consistency of the plurality of residual values.

In this way, one correction value is generated for a plurality of to-be-corrected residual values, so that the correction value can be generated more quickly, thereby improving the efficiency of correction value generation.

Manner 2: Generate, for each to-be-corrected residual value, a correction value corresponding to this residual value.

For example, for a plurality of to-be-corrected residual values, a correction value corresponding to each to-be-corrected residual value is generated. In other words, a plurality of correction values is generated. For example, refer to FIG. 10C again.

The process of generating, for each to-be-corrected residual value, a correction value corresponding to this residual value in manner 2 may include: selecting, for each to-be-corrected residual value from a plurality of candidate correction values, a correction value corresponding to this residual value according to an original value corresponding to this residual value.

In this way, the plurality of correction values is generated for the plurality of to-be-corrected residual values, and the fine granularity of the correction values is higher, thereby improving the accuracy of correction value generation.

The plurality of candidate correction values involved in manner 1 and manner 2 may be obtained through statistics by using historical correction values, or may be obtained through empirical setting or calculation.

S1320: Code the correction value to obtain a correction coding result, and obtain residual correction information according to the correction coding result.

In the aspects of this disclosure, a correction value corresponding to a to-be-corrected residual value is generated, the correction value may be coded to obtain a correction coding result, and then residual correction information is obtained according to the correction coding result.

In the aspects of this disclosure, a plurality of correction values are generated. Correspondingly, the process of coding the correction value to obtain a correction coding result, and obtain residual correction information according to the correction coding result in S1320 may include:
obtaining a mapping relationship between a correction value and a correction coding result, the mapping relationship between a correction value and a correction coding result including a plurality of correction values and correction coding results respectively corresponding to the plurality of correction values, and correction coding results corresponding to different correction values having different coding lengths;
obtaining a correction coding result corresponding to each generated correction value according to the mapping relationship between a correction value and a correction coding result; and
combining a plurality of correction coding results to obtain residual correction information.

For example, a mapping relationship between a correction value and a correction coding result is obtained, a correction coding result corresponding to each correction value is obtained by querying the mapping relationship between a correction value and a correction coding result, and then the plurality of correction coding results is combined, to obtain residual correction information.

The mapping relationship between a correction value and a correction coding result is stored in a specified storage region of the coder side. The stored mapping relationship is agreed by the coder side and the decoder side. Therefore, the mapping relationship between a correction value and a correction coding result can be obtained from the specified storage region.

The mapping relationship between a correction value and a correction coding result includes a plurality of correction values and correction coding results respectively corresponding to the plurality of correction values, and correction coding results corresponding to different correction values have different coding lengths. Since the correction value includes a correction sign and a correction absolute value, the mapping relationship between a correction value and a correction coding result is essentially a mapping relationship between a correction absolute value and a correction coding result. For example, the mapping relationship between a correction absolute value and a correction coding result includes correction absolute values and correction coding results respectively corresponding to the plurality of correction absolute values. Correction coding results corresponding to different correction absolute values have different coding lengths. For example, refer to Table 1 again.

In this way, the correction coding result corresponding to each correction value can be easily and accurately obtained according to the mapping relationship between a correction value and a correction coding result, so as to obtain the residual correction information.

In the aspects of this disclosure, before the process of obtaining a mapping relationship between a correction value and a correction coding result, the method may further include:
coding the plurality of generated correction values according to a VLC policy, to generate a correction coding result corresponding to each correction value; and
associating this correction value with the correction coding result corresponding to this correction value, and generating a mapping relationship between a correction value and a correction coding result.

For example, the plurality of generated correction values is coded according to a VLC policy, to generate a correction coding result corresponding to each correction value, and each correction value is associated with the correction coding result corresponding to each correction value, thereby generating a mapping relationship between a correction value and a correction coding result.

In this way, the correction value is coded by using the VLC policy, so that the mapping relationship between a correction value and a correction coding result can be easily and accurately obtained, thereby providing strong support for obtaining the correction coding result.

In the aspects of this disclosure, the process of coding the plurality of generated correction values according to a VLC policy, to generate a correction coding result corresponding to each correction value may include:
collecting statistics on a plurality of correction values generated by a historical block, to obtain an occurrence count of the same correction value;
determining a coding length of each correction value according to the occurrence count, the occurrence count being inversely proportional to the coding length; and
coding this correction value according to the coding length of this correction value, to obtain a correction coding result corresponding to this correction value.

For example, the occurrence count of the same correction value generated for a historical block is obtained through statistics in advance, a coding length of each correction value is determined according to the occurrence count, and then each correction value is coded according to the coding length of each correction value, to obtain a correction coding result corresponding to each correction value.

The historical block refers to a decoded image block in the current video frame, and includes, but is not limited to, a decoded image block that is most adjacent to and/or next adjacent to the current block.

The occurrence count of the same correction value is inversely proportional to the coding length of the correction value. For example, a larger occurrence count of the same correction value indicates a smaller coding length; otherwise, a smaller occurrence count of the same correction value indicates a larger coding length. For example, refer to Table 2 again.

In this way, the coding length of the correction value is determined by using the occurrence count, and coding is performed correspondingly, so that the coding of the correction value is more proper and flexible.

In the aspects of this disclosure, the process of obtaining a correction coding result corresponding to each generated correction value according to the mapping relationship between a correction value and a correction coding result may include:
obtaining a correction identifier corresponding to each generated correction value according to a mapping relationship between a correction identifier and a correction value; and
obtaining a correction coding result corresponding to each correction identifier according to a mapping relationship between a correction identifier and a correction coding result.

For example, a mapping relationship between a correction identifier and a correction value is queried to obtain a correction identifier corresponding to each correction value, and then a mapping relationship between a correction identifier and a correction coding result is queried to obtain a correction coding result corresponding to each correction identifier, thereby obtaining the correction coding result corresponding to each correction identifier.

The mapping relationship between a correction value and a correction coding result includes the mapping relationship between a correction identifier and a correction value, and the mapping relationship between a correction identifier and a correction coding result.

For example, the mapping relationship between a correction identifier and a correction value includes a plurality of correction identifiers and correction values respectively corresponding to the plurality of correction identifiers. Similarly, since the correction value includes a correction sign and a correction absolute value, the mapping relationship between a correction identifier and a correction value is essentially the mapping relationship between a correction identifier and a correction absolute value. For example, the mapping relationship between a correction identifier and a correction absolute value includes correction identifiers and correction absolute values respectively corresponding to the plurality of correction identifiers. For example, refer to Table 3 again. The correction identifier is configured for uniquely identifying the correction value.

The mapping relationship between a correction identifier and a correction coding result includes a plurality of correction identifiers and correction coding results respectively corresponding to the plurality of correction identifiers, and correction coding results corresponding to different correction identifiers have different coding lengths. For example, refer to Table 4 again.

In this way, by introducing correction identifiers, more ordered correction coding results can be obtained, thereby better implementing the coding of the correction value.

For detailed description of S1230 shown in FIG. 13, refer to S1230 shown in FIG. 12. Details are not described herein again.

In the aspects of this disclosure, a generated correction value is coded to obtain a correction coding result, and residual correction information is generated according to the correction coding result, thereby providing strong support for correction of a to-be-corrected residual value.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

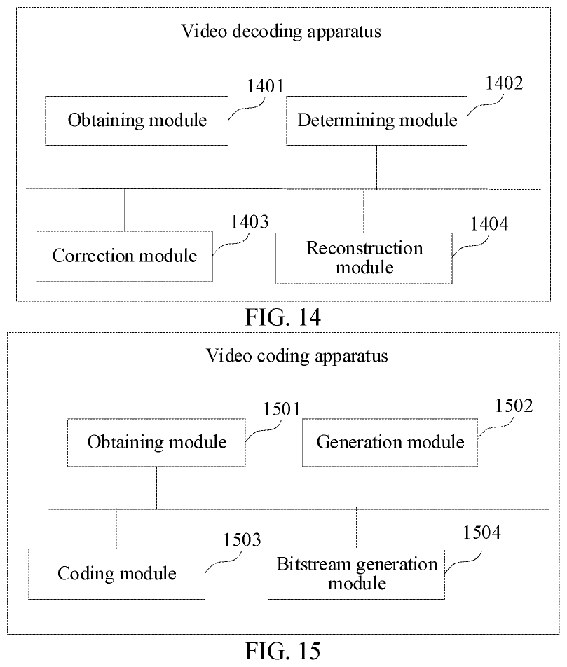

FIG. 14 is a block diagram of a video decoding apparatus according to an aspect of this disclosure. As shown in FIG. 14, the apparatus includes:
an obtaining module 1401, configured to obtain residual correction information corresponding to a current block, the current block being a to-be-decoded image block in a current video frame, and the residual correction information being generated by a coder side when a predictive coding mode corresponding to the current block is intra prediction;
a decoding module 1402, configured to decode a correction value from the residual correction information;
a determining module (not shown), configured to determine at least one to-be-corrected residual value corresponding to the current block;
a correction module 1403, configured to correct the to-be-corrected residual value by using the correction value, to obtain a corrected residual value; and
a reconstruction module 1404, configured to reconstruct the current block based on the corrected residual value.

The modules in the video decoding apparatus are configured to perform corresponding operations of the decoding method in the aspects of this disclosure. Therefore, specific functions of the modules are not described again, and the descriptions thereof may refer to the descriptions of the corresponding operations in the aspects.

In the aspects of this disclosure, based on the foregoing solution, a plurality of to-be-corrected residual values are included. The correction module 1403 is configured to:
extract a correction coding result from the residual correction information, and decode the correction coding result, to obtain a correction value; and
correct the plurality of to-be-corrected residual values respectively according to the correction value, to obtain a plurality of corrected residual values.

In the aspects of this disclosure, based on the foregoing solution, the correction module 1403 is further configured to:
sum, if a correction value is obtained through decoding, the correction value with each residual value, to obtain a plurality of corrected residual values; and
sum, if a plurality of correction values is obtained through decoding, each correction value with a residual value corresponding to each correction value, to obtain a plurality of corrected residual values.

In the aspects of this disclosure, based on the foregoing solution, the correction module 1403 is further configured to:
obtain, according to a position corresponding to each residual value, a correction coefficient corresponding to each residual value; and
multiply the correction value by the correction coefficient corresponding to each residual value, to obtain a product operation result corresponding to each residual value, and sum each residual value with the product operation result corresponding to each residual value, to obtain a plurality of corrected residual values.

In the aspects of this disclosure, based on the foregoing solution, the correction module 1403 is further configured to:
obtain, from a specified storage region, a correction coefficient corresponding to the position of each residual value, the stored correction coefficient being agreed by the coder side and a decoder side, the stored correction coefficient being directly proportional to a target distance, the target distance being a distance between a position of the to-be-corrected residual value in the current block and a reference region, and the reference region including a decoded image region adjacent to the current block.

In the aspects of this disclosure, based on the foregoing solution, a plurality of correction coding results is extracted. The correction module 1403 is further configured to:
obtain a mapping relationship between a correction value and a correction coding result, the mapping relationship between a correction value and a correction coding result including a plurality of correction values and correction coding results respectively corresponding to the plurality of correction values, and correction coding results corresponding to different correction values having different coding lengths; and
obtain a correction value corresponding to each extracted correction coding result according to the mapping relationship between a correction value and a correction coding result.

In the aspects of this disclosure, based on the foregoing solution, the correction module 1403 is further configured to:
obtain a correction identifier corresponding to each extracted correction coding result according to a mapping relationship between a correction identifier and a correction coding result; and
obtain a correction value corresponding to each correction identifier according to the mapping relationship between a correction identifier and a correction value.

In the aspects of this disclosure, based on the foregoing solution, an absolute value of the corrected residual value is less than an absolute value of a residual value before correction. Alternatively, if a plurality of to-be-corrected residual values are included, distribution consistency of the plurality of corrected residual values is greater than distribution consistency of the plurality of corrected residual values before correction.

In the aspects of this disclosure, based on the foregoing solution, the determining module 1402 is configured to:
select a to-be-corrected region from the current block, the to-be-corrected region being agreed by the coder side and the decoder side, and the to-be-corrected region including at least one of a lower image region in the current block and a right image region in the current block; and
determine a to-be-corrected residual value from a plurality of residual values included in the to-be-corrected region.

In the aspects of this disclosure, based on the foregoing solution, the determining module 1402 is further configured to:
select a non-zero residual value from the plurality of residual values included in the to-be-corrected region; and
take the non-zero residual value as a to-be-corrected residual value.

In the aspects of this disclosure, based on the foregoing solution, the reconstruction module 1404 is configured to:
determine another residual value other than the corrected residual value in the current block; and
obtain a reconstructed value of the current block according to the another residual value, the corrected residual value, and a predicted value corresponding to the current block.

FIG. 15 is a block diagram of a video coding apparatus according to an aspect of this disclosure. As shown in FIG. 15, the apparatus includes:
an obtaining module 1501, configured to obtain a predictive coding mode corresponding to a current block, the current block being a to-be-decoded image block in a current video frame;
a generation module 1502, configured to generate, in response to determining that the predictive coding mode corresponding to a to-be-coded current block in a video image is intra prediction, residual correction information corresponding to the current block, the residual correction information being configured for correcting a to-be-corrected residual value corresponding to the current block, and obtaining a reconstructed value of the current block according to the corrected residual value;
a coding module 1503, configured to code a correction value into the residual correction information; and
a bitstream generation module 1504, configured to code the residual correction information into a coded video bitstream corresponding to the video image.

The modules in the video coding apparatus are configured to perform corresponding operations of the coding method in the aspects of this disclosure. Therefore, specific functions of the modules are not described again, and the descriptions thereof may refer to the descriptions of the corresponding operations in the aspects.

In the aspects of this disclosure, based on the foregoing solution, the generation module 1502 is configured to:
determine a to-be-corrected residual value corresponding to the current block, and generate a correction value corresponding to the to-be-corrected residual value; and
code the correction value to obtain a correction coding result, and obtain the residual correction information according to the correction coding result.

In the aspects of this disclosure, based on the foregoing solution, a plurality of to-be-corrected residual values are included. The generation module 1502 is further configured to:
generate a correction value for a plurality of to-be-corrected residual values; or
generate, for each to-be-corrected residual value, a correction value corresponding to this residual value.

In the aspects of this disclosure, based on the foregoing solution, the generation module 1502 is further configured to:
select, for a plurality of to-be-corrected residual values from a plurality of candidate correction values, a correction value enabling maximum overall reduction or maximum overall distribution consistency of the plurality of residual values; or
select, for each to-be-corrected residual value from a plurality of candidate correction values, a correction value corresponding to this residual value according to an original value corresponding to this residual value.

In the aspects of this disclosure, based on the foregoing solution, a plurality of correction values is generated. The generation module 1502 is further configured to:
obtain a mapping relationship between a correction value and a correction coding result, the mapping relationship between a correction value and a correction coding result including a plurality of correction values and correction coding results respectively corresponding to the plurality of correction values, and correction coding results corresponding to different correction values having different coding lengths;
obtain a correction coding result corresponding to each generated correction value according to the mapping relationship between a correction value and a correction coding result; and
combine a plurality of correction coding results to obtain residual correction information.

In the aspects of this disclosure, based on the foregoing solution, the apparatus further includes an association module, configured to:
code the plurality of generated correction values according to a VLC policy, to generate a correction coding result corresponding to each correction value; and
associate this correction value with the correction coding result corresponding to this correction value, and generate a mapping relationship between a correction value and a correction coding result.

In the aspects of this disclosure, based on the foregoing solution, the association module is configured to:
collect statistics on a plurality of correction values generated by a historical block, to obtain an occurrence count of the same correction value;
determine a coding length of each correction value according to the occurrence count, the occurrence count being inversely proportional to the coding length; and
code this correction value according to the coding length of this correction value, to obtain a correction coding result corresponding to this correction value.

In the aspects of this disclosure, based on the foregoing solution, the generation module 1502 is further configured to:
obtain a correction identifier corresponding to each generated correction value according to a mapping relationship between a correction identifier and a correction value; and
obtain a correction coding result corresponding to each correction identifier according to a mapping relationship between a correction identifier and a correction coding result.

In the aspects of this disclosure, based on the foregoing solution, the generation module 1502 is further configured to:
select a to-be-corrected region from the current block, the to-be-corrected region being agreed by the coder side and the decoder side, and the to-be-corrected region including at least one of a lower image region in the current block and a right image region in the current block; and
determine a to-be-corrected residual value from a plurality of residual values included in the to-be-corrected region.

In the aspects of this disclosure, based on the foregoing solution, the generation module 1502 is further configured to:
select a non-zero residual value from the plurality of residual values included in the to-be-corrected region; and
take the non-zero residual value as a to-be-corrected residual value.

The video coding apparatus and the video decoding apparatus provided in the foregoing aspects and the video coding method and the video decoding method provided in the foregoing aspects belong to the same idea. Specific manners in which the modules and units perform operations have been described in further detail in the method aspects. Details are not described herein again. In an actual application of the video coding apparatus and the video decoding apparatus provided in the foregoing aspects, the foregoing functions may be allocated to and completed by different function modules according to requirements. For example, internal structures of the apparatuses are divided into different function modules to complete all or some of the functions described above. This is not limited herein.

An aspect of this disclosure further provides an electronic device, including: processing circuitry (e.g., one or more processors); and a memory, configured to store one or more programs, the one or more programs, when executed by the one or more processors, causing the electronic device to implement the video coding method and the video decoding method provided in the aspects of this disclosure.

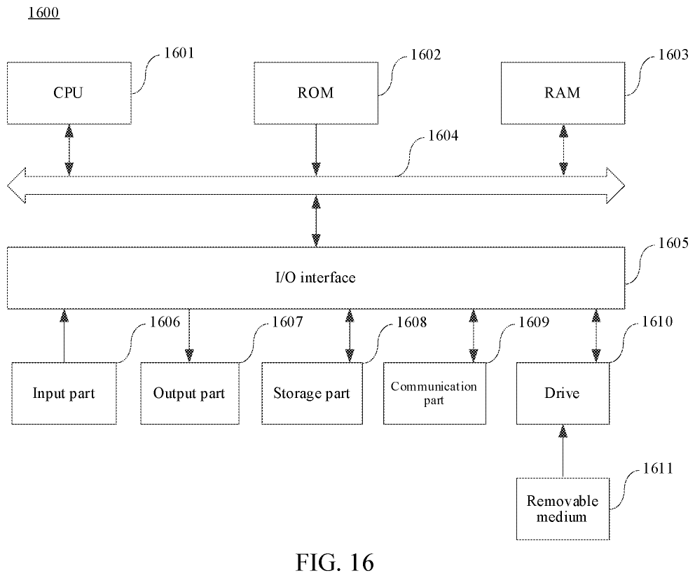

FIG. 16 is a schematic structural diagram of a computer system suitable for implementing an electronic device according to an aspect of this disclosure. A computer system 1600 of an electronic device shown in FIG. 16 is merely an example, and does not constitute any limitation on the function and scope of use of the aspects of this disclosure.

As shown in FIG. 16, the computer system 1600 includes a central processing unit (CPU) 1601, which may perform various suitable actions and processes based on a program stored in a read-only memory (ROM) 1602 or a program loaded from a storage part 1608 into a random access memory (RAM) 1603, for example, perform the method in the foregoing aspects. The RAM 1603 further has various programs and data required for system operation stored therein. The CPU 1601, the ROM 1602, and the RAM 1603 are connected to each other through a bus 1604. An input/output (I/O) interface 1605 is also connected to the bus 1604.

The following components are connected to the I/O interface 1605: an input part 1606 including a keyboard, a mouse, and the like; an output part 1607 including a cathode ray tube (CRT), a liquid crystal display (LCD), a speaker, and the like; a storage part 1608 including a hard disk and the like; and a communication part 1609 including a network interface card such as a LAN card or a modem. The communication part 1609 performs communication processing by using a network such as the Internet. A drive 1610 is also connected to the I/O interface 1605 as required. A removable medium 1611 such as a magnetic disk, an optical disk, a magneto-optical disk, or a semiconductor memory is installed on the drive 1610 as required, so that a computer program read from the removable medium is installed into the storage part 1608 as required.

In particular, according to the aspects of this disclosure, the process described above with reference to the flowchart may be implemented as a computer software program. For example, an aspect of this disclosure includes a computer program product, including a computer program carried on a computer-readable medium (e.g., a non-transitory computer-readable storage medium). The computer program includes a computer program for performing the method shown in the flowchart. In such an aspect, the computer program may be downloaded and installed from a network through the communication part 1609, and/or installed from the removable medium 1611. When the computer program is executed by the CPU 1601, various functions defined in the system of this disclosure are performed.

Some implementations may involve systems, methods, and/or computer-readable media at any possible level of integrated technical detail. The computer-readable medium may include a computer-readable non-transient storage medium (or media). The computer-readable non-transient storage medium has computer-readable program instructions therein for causing a processor to perform operations, and may further include a bitstream (or video bitstream) generated according to the foregoing coding method. The computer program/instructions, when executed by the processor, may implement the operations of the video coding method to generate the bitstream (or video bitstream), or implement the operations of the video decoding method to decode the bitstream (or video bitstream).

The computer-readable medium shown in this aspect of this disclosure may be a computer-readable signal medium, a computer-readable storage medium, or any combination of the two media. More specific examples of the computer-readable storage medium may include, but are not limited to, an electrical connection having one or more wires, a portable computer magnetic disk, a hard disk, a RAM, a ROM, an erasable programmable read-only memory (EPROM), a flash memory, an optical fiber, a portable compact disc read-only memory (CD-ROM), an optical storage device, a magnetic storage device, or any suitable combination of the foregoing. The computer program included in the computer-readable medium may be transmitted by using any suitable medium, including but not limited to: a wireless medium, a wired medium, and the like, or any suitable combination of the foregoing.

The flowcharts and block diagrams in the accompanying drawings illustrate possible system architectures, functions, and operations that may be implemented by a system, a method, and a computer program product according to various aspects of this disclosure. Each box in the flowchart or the block diagram may represent a module, a program segment, or a part of code. The module, the program segment, or the part of the code includes one or more executable instructions for implementing a specified logical function. In some alternative implementations, functions annotated in the boxes may be executed in a different order from those annotated in the accompanying drawings. For example, two boxes shown in succession may actually be performed basically in parallel, and sometimes the two boxes may be performed in a reverse order. This depends on the functions involved. Each box of the block diagrams or the flowcharts and combinations of boxes in the block diagrams or the flowcharts may be implemented by a dedicated hardware-based system that performs specified functions or operations, or may be implemented by a combination of dedicated hardware and a computer instruction.

Described units involved in the aspects of this disclosure may be implemented in software or hardware. The described units may alternatively be disposed in a processor. The names of these units do not constitute a limitation on the units under particular circumstances.

Another aspect of this disclosure further provides a computer-readable storage medium (e.g., a non-transitory computer-readable storage medium), having a computer program stored therein. The computer program, when executed by a processor, implements the video coding methods and the video decoding methods described above. The computer-readable storage medium may be included in an electronic device described in the foregoing aspects or may exist separately without being assembled into the electronic device.

Another aspect of this disclosure further provides a computer program product or computer program. The computer program product or computer program includes computer instructions, and the computer instructions are stored in a computer-readable storage medium (e.g., a non-transitory computer-readable storage medium). A processor of a computer device reads the computer instructions from the computer-readable storage medium, and the processor executes the computer instructions, so that the computer device performs the video coding methods and the video decoding methods provided in the foregoing aspects of this disclosure.

The technical features of the foregoing aspects may be combined in any manner. For the sake of brevity, not all possible combinations of the technical features in the foregoing aspects have been described. However, any combination of these technical features is to be considered within the scope of this specification, provided that no contradiction arises.

The foregoing contents are merely examples of aspects of this disclosure and are not intended to limit the aspects of this disclosure. Those of ordinary skill in the art can make corresponding variations or modifications according to the disclosed aspects of this disclosure.

What is claimed is:

1. A video decoding method, comprising:
obtaining, from a bitstream, residual correction information corresponding to a current block that is intra-coded;
decoding a correction value from the residual correction information;
correcting at least one residual value of the current block based on the correction value to obtain a corrected residual value; and
reconstructing the current block based on the corrected residual value.

2. The method according to claim 1, wherein the decoding comprises:
decoding a first bit string from the residual correction information; and
determining a value corresponding to the first bit string based on a preset mapping relationship.

3. The method according to claim 1, wherein the decoding comprises:
decoding a sign of the correction value from sign information in the residual correction information; and
decoding an absolute value of the correction value from value information in the residual correction information.

4. The method according to claim 2, wherein the decoding comprises:
generating context information based on a second bit string corresponding to an adjustment value of at least one previously decoded block; and
decoding the first bit string from the residual correction information based on a preset context model-based coding algorithm being applied to the context information.

5. The method according to claim 1, wherein the correcting comprises:
correcting a residual value corresponding to a first preset position in the current block based on the correction value;
deriving a plurality of second correction values corresponding to a plurality of second preset positions in the current block based on the correction value; and
correcting residual values corresponding to the plurality of second preset positions based on the plurality of second correction values.

6. The method according to claim 5, wherein the deriving comprises:
calculating a product of the correction value and a correction coefficient corresponding to each second preset position as the second correction value corresponding to the respective second preset position.

7. The method according to claim 6, wherein the correction coefficients are pre-stored or included in the bitstream.

8. The method according to claim 6, wherein the correction coefficient corresponding to each second preset position is positively correlated with a distance between the respective second preset position and a reference region decoded for intra prediction of the current block.

9. The method according to claim 1, wherein the residual correction information comprises information of at least two correction values, and the decoding comprises:
decoding at least two correction values based on the information of the at least two correction values in the residual correction information.

10. The method according to claim 1, wherein
an absolute value of the corrected residual value is less than an absolute value of a residual value before correction; or
a distribution consistency of at least two corrected residual values is greater than a distribution consistency of at least two residual values before correction.

11. The method according to claim 1, further comprising:
selecting a region from the current block, the region comprising at least one of a lower image region in the current block and a right image region in the current block; and
determining the at least one residual value from a plurality of residual values in the region.

12. The method according to claim 11, wherein the determining comprises:
determining a non-zero residual value among the plurality of residual values in the region as the at least one residual value.

13. A video encoding method, comprising:
determining a predictive coding mode corresponding to a current block in a video image is intra prediction;
generating a correction value corresponding to the current block;
encoding the correction value into residual correction information; and
encoding the residual correction information into a coded video bitstream corresponding to the video image.

14. The method according to claim 13, wherein the encoding the correction value comprises:
determining a first bit string corresponding to the correction value based on a preset mapping relationship; and
encoding the first bit string into the residual correction information.

15. The method according to claim 13, wherein the encoding the correction value comprises:
encoding a sign of the correction value into sign information in the residual correction information; and
encoding an absolute value of the correction value into value information in the residual correction information.

16. The method according to claim 14, wherein the encoding the first bit string comprises:
generating context information based on a second bit string corresponding to an adjustment value of at least one previously coded block; and
encoding the first bit string into the value information based on a preset context model-based coding algorithm being applied to the context information.

17. A non-transitory computer-readable storage medium storing instructions which, when executed by a processor, cause the processor to perform a method of encoding a video bitstream, the method comprising:
determining a predictive coding mode corresponding to a current block in a video image is intra prediction;
generating a correction value corresponding to the current block;
encoding the correction value into residual correction information;
encoding the residual correction information into a coded video bitstream corresponding to the video image; and
transmitting the coded video bitstream.

18. The method according to claim 17, wherein the encoding the correction value comprises:
determining a first bit string corresponding to the correction value based on a preset mapping relationship; and
encoding the first bit string into the residual correction information.

19. The method according to claim 17, wherein the encoding the correction value comprises:
encoding a sign of the correction value into sign information in the residual correction information; and
encoding an absolute value of the correction value into value information in the residual correction information.

20. The method according to claim 19, wherein the encoding the first bit string comprises:
generating context information based on a second bit string corresponding to an adjustment value of at least one previously coded block; and
encoding the first bit string into the value information based on a preset context model-based coding algorithm being applied to the context information.
